(19) United States
(12) Patent Application Publication
(10) Pub. No.: US 2007/0072042 A1
(43) Pub. Date: Mar. 29, 2007

(54) PORTABLE FUEL CELL POWER SOURCE

(76) Inventors: Duhane Lam, Vancouver (CA); Jean-Louis Iaconis, Vancouver (CA); Joerg Zimmermann, Vancouver (CA); Tran Ngo, Burnaby (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/535,054

(22) Filed: Sep. 25, 2006

Related U.S. Application Data
(60) Provisional application No. 60/719,605, filed on Sep. 23, 2005.
(60) Provisional application No. 60/719,603, filed on Sep. 23, 2005.
(60) Provisional application No. 60/757,782, filed on Jan. 9, 2006.

(51) Int. Cl. H01M 8/04; B67D 5/00

(52) U.S. Cl. 429/34; 429/13; 222/3

(57) ABSTRACT

A portable fuel cell power source including a fuel reservoir for storage of fuel which is provided to one or more fuel cells for generating electricity. The fuel supply is controlled by a fuel supply on-off switch. The electricity produced may be optionally modulated by power conditioning electronics before being supplied to an extrinsic device through an electrical connector. The electrical connector may be of a standard or universal type that is found in or may be incorporated into many different types of portable electronic devices. Fuel is supplied to the fuel reservoir via a refueling port which is adapted to be connected to different extrinsic refueling sources, including both stationary and portable refueling sources.

### CROSS REFERENCE TO RELATED APPLICATIONS

This application claims the benefit under 35 U.S.C. §119 of U.S. provisional patent applications No. 60/719,605 entitled “Portable Fuel Cell Power Source” filed 23 Sep. 2005, No. 60/719,603 entitled “Method and Apparatus for Refueling Reversible Metal Hydride Hydrogen Storage System” filed 23 Sep. 2005, and No. 60/757,782 entitled “Cellular Reservoir and Methods Related Thereto” filed 9 Jan. 2006, all of which are hereby incorporated by reference.

### TECHNICAL FIELD

This invention relates to power sources for electrical devices. The invention relates specifically to power sources that comprise fuel cells for generating electrical power.

### BACKGROUND

Fuel cells employ an electrochemical reaction to convert a fuel, such as hydrogen, and an oxidant, such as oxygen directly (without combustion) into electricity.

Many fuel cells and fuel cell systems are designed as large automotive or stationary systems. These systems typically have significant amounts of balance of plant components, such as compressors, humidifiers, heaters, coolers, and other such components. Such systems are large, complex and expensive to operate.

There have been a number of attempts to produce portable power sources incorporating fuel cell technology. However, these attempts suffer from a number of disadvantages. For example, some of these portable power sources are too large to be conveniently carried and transported. In some cases, the portable power source is not re-usable and must be disposed of after a single use. This generates a large amount of garbage and wasted materials, similar to disposable batteries. In another attempt, the power source is reusable but in order to refuel the power source, the fuel reservoir must be taken out of the power source before it can be refilled. This is inconvenient and makes the system more difficult to use.

Small portable devices such as cellular telephones, radios, portable lights, games, music players, digital cameras, and many other types of portable devices are typically powered by batteries. Battery technology has limits and is not keeping up with the demand for power.

A need therefore exists for portable power sources capable of powering or charging the batteries in portable electronic devices while overcoming the above disadvantages. A need exists for extending the run time of portable electronic devices and for increasing the operating range of portable devices while away from an electrical power grid.

### SUMMARY

One aspect of the present invention provides a portable fuel cell power source that can be used for powering a wide variety of portable electronic devices and for other applications. The power source can be used either to provide power to a portable electronic device directly, or it can be used to charge a battery in a portable electronic device. The power source can be run as an external unit or it can be adapted such that it is or can be integrated into a portable device. Power sources according to some embodiments of the invention can be refueled using a variety of refueling devices.

Further aspects of the invention and features of embodiments of the invention are described below.

### BRIEF DESCRIPTION OF DRAWINGS

In drawings that illustrate non-limiting embodiments of the invention:

FIG. 1 is a perspective view of a portable fuel cell power source according to one embodiment of the invention;

FIG. 2 is an exploded perspective view of the FIG. 1 portable fuel cell power source;

FIG. 3 is a schematic diagram showing the connections between some of the parts of the FIG. 1 portable fuel cell power source;

FIG. 4 is a schematic diagram of a power system including a portable fuel cell power source according to an embodiment of the invention;

FIG. 5 is a perspective view showing the FIG. 1 portable fuel cell power source being refueled in a refueling station;

FIG. 6 is a perspective view showing a portable fuel cell power source and a portable refueling cartridge;

FIG. 7 is a perspective view showing a portable fuel cell power source being refueled by a portable refueling cartridge;

FIG. 8 is a cross-sectional view of a portable fuel cell power source being refueled by a portable refueling cartridge.

### DESCRIPTION

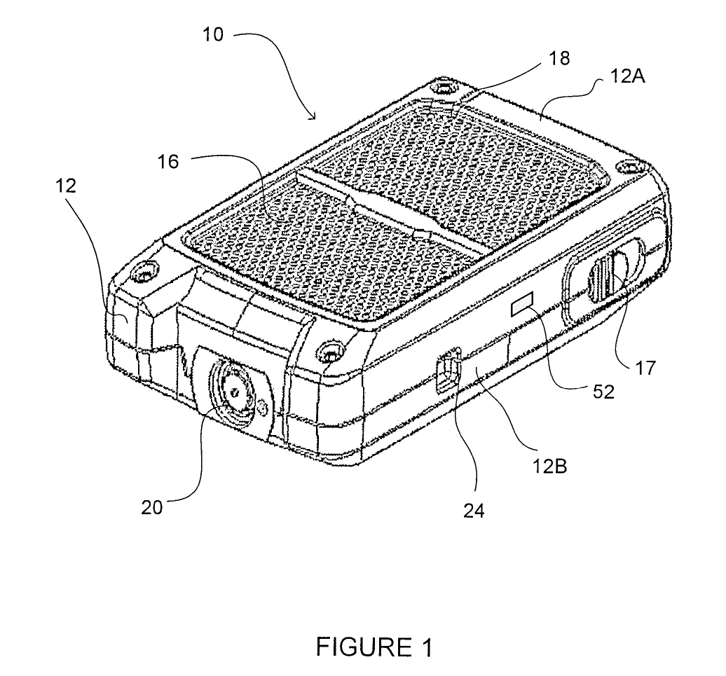

FIG. 1 shows an embodiment of a portable fuel cell power source 10. Power source 10 has a case 12. To facilitate portability, some embodiments of portable device 10 have volumes in the range of 1 cc to 1000 cc or 3 to 250 cc. The illustrated case has an upper part 12A and a bottom part 12B. Case parts 12A and 12B may be made of plastic or any number of other suitable materials including but not limited to metal, wood and composites.

In some embodiments, power source 10 comprises an array of fuel cells 26 that operate in a passive, air-breathing manner. Fuel cells 26 of this embodiment obtain oxygen from the ambient environment (air) as the oxidant in the fuel cell reaction. In some such embodiments, upper case part 12A has a grille 16 disposed such that air can enter through grille 16 to allow fluidic communication between ambient air and the passive air-breathing fuel cells 26 located inside case 12.

Fuel cells 26 may consume any suitable fuel. In some embodiments fuel cells 26 consume hydrogen as a fuel. In other embodiments, the fuel cells consume other fuels. Non-limiting examples of other fuels that may be consumed by fuel cells 26 are: methanol; formic acid; butane; and borohydride compounds.

Grille 16 may be attached to upper case part 12A and can be made from perforated stainless steel. The perforated stainless steel materials used in this embodiment have holes in the range of about 0.010″ to 0.5″ in diameter. The open area of grille 16 in some embodiments comprises from 5% to 95% of the total area of grille 16. In some such embodiments, the open area of grille 16 comprises 20% to 85% of the total area of grille 16. Other dimensions and materials for grille 16 are also possible, as long as grille 16 permits sufficient air access to fuel cells 26. Other possible materials for grille 16 include, but are not limited to, expanded steel mesh, or other perforated metals such as aluminum, plastic grilles, porous plastics, etc. Where power source 10 will be used in conditions such that it is necessary or desirable to protect fuel cells 26 from contaminants, then grille 16 may comprise or be augmented by a layer of a porous plastic, such as porous Teflon®.

The embodiment of FIGS. 1 to 4 comprises an on-off switch 17 that turns power source 10 on and off. The on-off switch may be actuated mechanically or electrically.

In the embodiment illustrated in FIGS. 1 to 4, on-off switch 17 is a fluidic switch which can be switched to either open or cut off the fuel supply to fuel cells 26. On-off switch 17 is not an electrical on-off switch in this embodiment. Electrical switches which operate solely to switch on or off the electrical output from a fuel cell do not prevent fuel from flowing into fuel cells 26 and can therefore allow wastage of fuel. By cutting off the fuel supply to fuel cells 26, a fluidic switch 17 can reduce wastage of fuel and thus promote overall higher power generating efficiency.

An indicator light 18 may be provided to provide user feedback, indicate when power source 10 has power, or combinations thereof. Indicator light 18 may comprise a light source, such as an LED. In the illustrated embodiment, a light pipe 44 transmits light from a LED mounted on a circuit board inside power source 10. If power source 10 is out of fuel, indicator light 18 will not illuminate even if on-off switch 17 is on. In the illustrated embodiment, indicator light 18 will stay lit for a while even after on-off switch 17 is shut off because residual fuel remains in the system. The indicator light 18 will stay lit until the residual fuel is used up.

A refueling port 20 is provided on power source 10. Refueling port 20 permits replenishing of the supply of fuel for power source 10. The fuel is stored on-board power source 10 in a fuel reservoir 22. Fuel reservoir 22 may be integral with power source 10 or may be designed to be removable. The design of fuel reservoir 22 may depend upon the nature of the fuel used by power source 10.

As discussed in more detail below, power source 10 can be refueled in a variety of different ways through refueling port 20. One way of refueling power source 10 is through the use of a refueling station 56. One or more notches 24 or other locating features may be provided on case 12 or in refueling port 20 for holding power source 10 when refueling in refueling station 56. Another way of refueling power source 10 is through the use of a portable refueling cartridge 58. In some embodiments, fuel reservoir 22 and refueling port 20 are as described in the commonly-owned co-pending United States patent application entitled “METHODS AND APPARATUS FOR REFUELING REVERSIBLE HYDROGEN-STORAGE SYSTEMS” being filed simultaneously herewith, which is hereby incorporated herein by reference. Where hydrogen fuel is used by fuel cells 26, power source 10 may be refueled in the manner described in that application.

Power source 10 can be used for charging the batteries of a portable electronic device, or it can be used for running a portable electronic device directly. As discussed below, power source 10 is provided with an electrical connector 52 for use in connecting power source 10 to an external electronic device. An electrical output of fuel cells 26 may be connected to electrical connector 52 directly or by way of suitable power conditioning electronics 28.

The output of power source 10 in an example embodiment is a 5 V DC output. However, the output can be any other DC output. For example, power source 10 could be configured to provide a direct current output voltage in the range of 0.5 V to 60 V by making an appropriate selection of fuel cells 26. Other voltages as well as non-DC voltages such as AC voltages may be achieved through the use of appropriate power conditioning electronics 28. DC-to-DC converters and inverters which convert DC power to AC power are well known to those skilled in the art and may be included in power conditioning electronics 28.

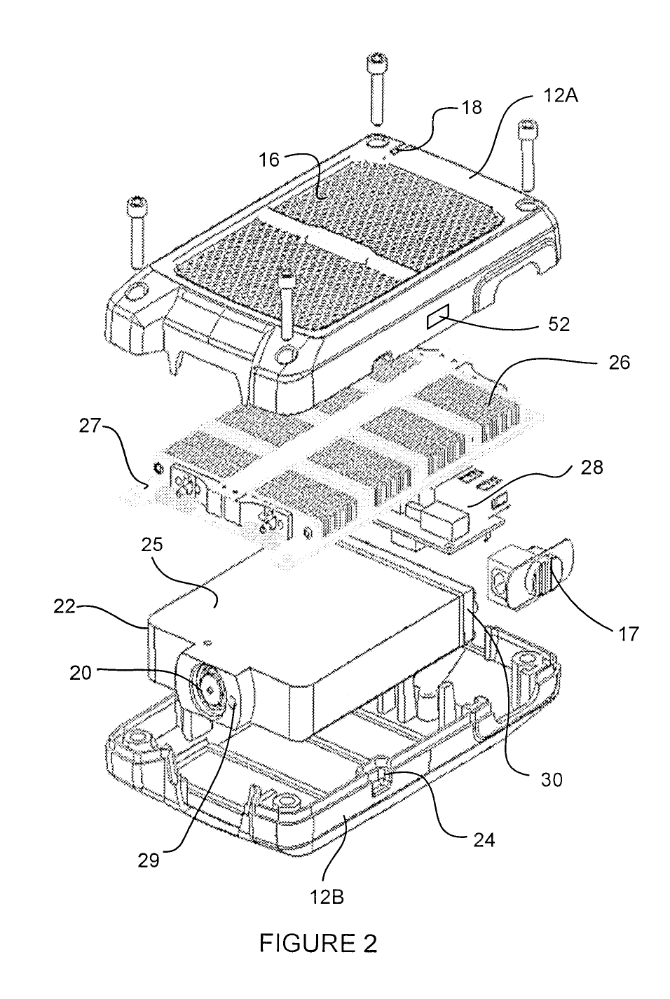

FIG. 2 is an exploded view of an example embodiment of power source 10. FIG. 2 shows power source 10, fuel reservoir 22, on-off switch 17, an array of fuel cells 26, and power conditioning electronics 28. In some such embodiments, fuel reservoir 22 stores hydrogen in a reversible hydrogen-storage material such as a metal hydride material. A wide range of such materials is known to those skilled in the field of designing hydrogen storage systems. One example of a reversible metal hydride material that may be used as a hydrogen-storage material is Lanthanum Nickel (LaNi₅), available from Alfa Aesar of Ward Hill, Mass., USA. Other reversible hydrogen-storage materials may also be used where fuel cells 26 consume hydrogen as a fuel. Hydrogen is then held in the reversible hydrogen-storage material in fuel reservoir 22 until needed.

Reversible hydrogen-storage materials have the advantage of being able to store hydrogen quite densely from a volumetric point of view. Volumetric energy density is important for portable electronic devices since maintaining relatively small sizes of such devices may be important in some applications. Embodiments where hydrogen fuel is supplied from a reversible hydrogen-storage material can offer the advantage of storing pure dry hydrogen for delivery to fuel cells 26.

Fuel reservoir 22 may be integrated into power source 10 or may be removable. Fuel reservoir 22 may have any of a wide range of constructions. For example, fuel reservoir 22 may comprise a cellular reservoir as disclosed in U.S. provisional patent application No. 60/757,782 entitled “Cellular reservoir and methods related thereto” filed 9 Jan. 2006, which is hereby incorporated by reference.

Fuel reservoir 22 may optionally be segmented into a number of compartments which store reversible hydrogen-storage material. Internal structures may be provided in fuel reservoir 22 to provide mechanical strength, provide segmentation of fuel reservoir 22, assist in heat transfer, or the like. Such internal structure, if present, may be cellular, honeycomb, or have some other configuration.

A pressure relief valve 29 prevents pressure inside fuel reservoir 22 from building up too high. Pressure relief valve 29 may also act as a safety mechanism to prevent excessive pressure build-up in fuel reservoir 22 or in a refueling cartridge 58 while fuel reservoir 22 is in fluid communication with portable refueling cartridge 58 as discussed in more detail below.

In some embodiments, a pressure regulator 30 is disposed between fuel reservoir 22 and fuel cells 26. In such embodiments, pressure regulator 30 regulates the pressure of fuel supplied from fuel reservoir 22 to fuel cells 26. In one example embodiment, fuel reservoir 22 contains hydrogen as a fuel stored in a reversible hydrogen-storage material having a charge pressure of about 150 psi and a plateau (or “desorption”) pressure of roughly 30 psi. Other charge and plateau pressures are also possible by appropriate selection of hydrogen-storage material in fuel reservoir 22.

Pressure regulator 30, when present, controls the flow of fuel from outlet 34 of fuel reservoir 22. Pressure regulator 30 steps the pressure from fuel reservoir 22 down to a pressure suitable for fuel cells 26. For example, various fuel cells 26 can be operated with hydrogen supply pressures in the range of approximately: 0.1 to 100 psi or 0.3 to 30 psi or 0.5 to 5 psi. Pressure regulator 30 may regulate the pressure of fuel being supplied to fuel cells 26 to be within one of these ranges. Other fuel cells may require fuel to be supplied at a pressure within some other range of pressure pressures.

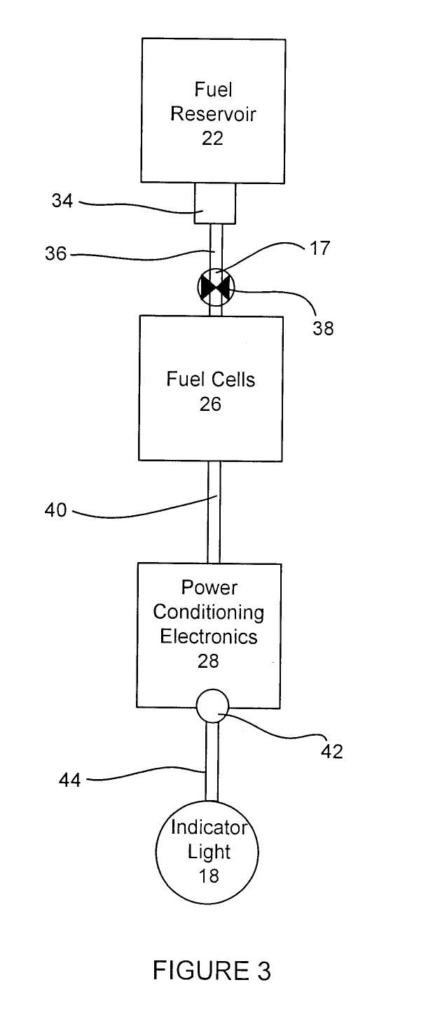

As shown schematically in FIG. 3, an outlet 34 of fuel reservoir 22 is connected to a fuel supply line such as a suitable hose 36. A flexible ⅛″ OD silicone hose is used in a prototype embodiment, but other types of hose or conduit may be used for the fuel supply line. On-off switch 17 is attached to fuel reservoir 22 and has a cam mechanism 38 that shuts the supply of fuel to fuel cells 26 off by pinching or otherwise obstructing hose 36. Hose 36 is connected to the input or inputs of an array of fuel cells 26.

In the illustrated embodiment, the array of fuel cells 26 comprises eight fuel cell modules, two rows of four fuel cell modules each, arranged electrically in parallel (FIG. 2). Other suitable configurations are also possible. For example, a power source 10 may have one or more fuel cell modules 26. Where there are multiple fuel cell modules, fuel may be fed separately to each module, fed through the fuel cell modules in series, or fed simultaneously through different rows of fuel cells 26. In the illustrated embodiment, fuel is fed through each row of fuel cell modules in parallel.

Suitable fuel cell modules are made by Angstrom Power Inc., of North Vancouver, Canada. Each fuel cell module may have an open circuit voltage (OCV) of approximately 9 V and an operating voltage of approximately 5 to 6 V, for example. Different voltages are possible by using different fuel cell modules or by combining fuel cell modules in different series and parallel connections.

Fuel cells 26 may have any of a wide range of constructions and configurations. Some non-limiting examples of fuel cells that may be used as fuel cells 26 are described in the following United States patents and patent applications:
U.S. Pat. No. 7,052,795 entitled Compact Chemical Reactor,
U.S. Pat. No. 7,063,910 entitled Compact Chemical Reactor with Reactor Frame,
U.S. Pat. No. 6,969,563 entitled High Power Density Fuel Cell Stack Using Micro Structured Components;
U.S. Ser. No. 11/047,557 entitled Electrochemical Cells Formed on Pleated Substrates;
U.S. Ser. No. 11/047,558 entitled Membranes and Electrochemical Cells Incorporating Such Membranes;
U.S. Ser. No. 11/047,560 Entitled Electrochemical Cells Having Current-carrying Structures Underlying Electrochemical Reaction Layers; and the following PCT patent application:
WO2005/097311 Entitled Chemical Reactors and Methods for Making Same;
   all of which are hereby incorporated herein by reference.

In the embodiment illustrated in FIG. 2, fuel cells 26 are electrically connected in parallel and are connected to power conditioning electronics 28 through a connector 40 (FIG. 3). Power conditioning electronics 28 takes the output of fuel cells 26 as input and provides a regulated DC output. A step-down DC-DC converter is used in this embodiment. The circuit board for power conditioning electronics 28 also has a LED 42 that is connected to indicator light 18 by way of light pipe 44. LED 42 lights up when the output of power conditioning electronics 28 is above a certain voltage level

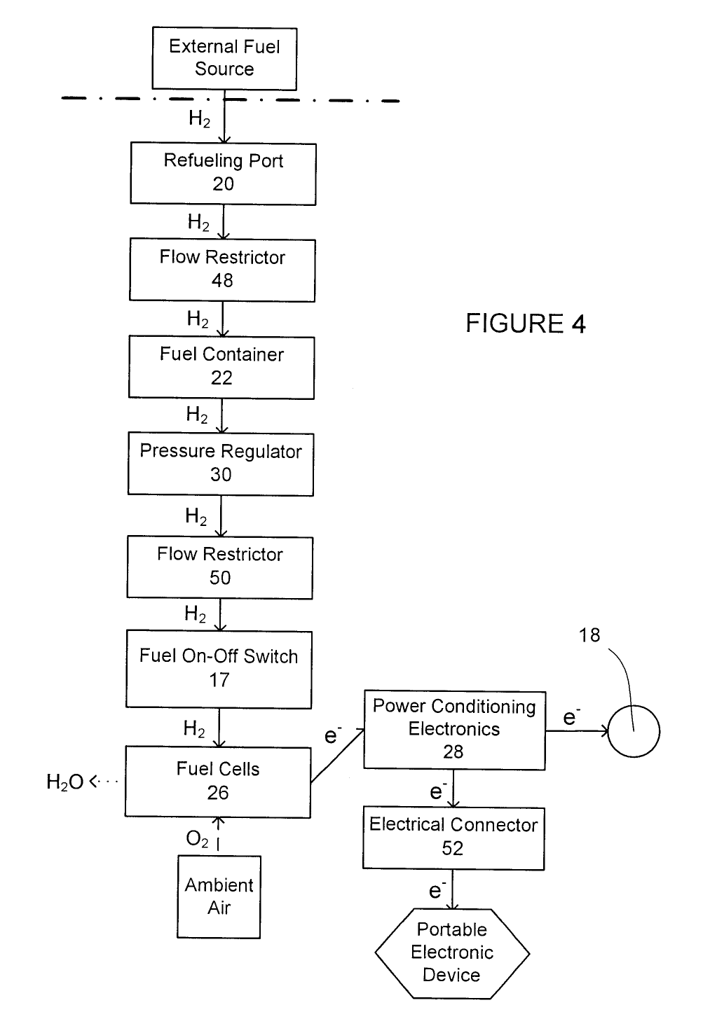

FIG. 4 is a schematic diagram of an embodiment of a power system including power source 10. Hydrogen gas is introduced into refueling port 20 from an external fuel source. In some embodiments, a flow restrictor 48 limits the flow rate of the hydrogen from the external fuel source into the reversible hydrogen-storage material within fuel reservoir 22. Flow restrictor 48 can be in the form of an orifice, a flow element, a porous material, a valve, or some other suitable type of flow-restricting element. The reversible hydrogen-storage material can take up hydrogen at a thermally-limited rate. A flow restrictor 48 can help to keep the reversible hydrogen-storage material from being refueled too quickly. A flow restrictor is not present in all embodiments.

An output flow restrictor 50 may be provided in order to limit the flow rate of fuel to fuel cells 26. Output flow restrictor 50 can be in the form of an orifice, a laminar flow element, a porous material, a valve, or some other type of flow-restricting element. In the illustrated embodiment, output flow restrictor 50 is shown between pressure regulator 30 and fuel on-off switch 17. The output flow restrictor 50 could be located between fuel reservoir 22 and pressure regulator 30, or between fuel on-off switch 17 and fuel cells 26, or it could be omitted altogether. An output flow restrictor could be integrated into pressure regulator 30, if present.

As discussed above, the fuel on-off switch 17 selectively allows or inhibits the flow of fuel to fuel cells 26. In this embodiment, no additional compressors, humidifiers, or heaters are typically required for the fuel as in some other fuel cell systems.

Fuel cells 26 use fuel from fuel reservoir 22 and ambient air from the environment to create electricity through an electrochemical reaction. Where the fuel is hydrogen, the reaction produces water vapour as its byproduct. The electrical output from fuel cells 26 is fed into power conditioning electronics 28 and is regulated to an output voltage. Some of the electricity is used to power indicator light 18. The regulated output can be directed to an electrical connector 52 that allows for connection to external portable electronic devices as described in U.S. patent application Ser. No. 11/342,005 entitled Fuel cell charger filed 27 Jan. 2006, which is hereby incorporated by reference. As disclosed in U.S. Ser. No. 11/342,005, electrical connector 52 may be a standard or universal type of port found on many electronic devices. For example, electrical connector 52 may be a communications port, such as a Universal Serial Bus (USB) port, which is incorporated into many electronic devices. Electrical connector 52 comprising such a port allows power source 10 to charge a variety of electronic devices without the need for specific chargers or adapters. The system can be used to charge the battery in an external electronic device, or it can be used to power a load directly.

As best seen in FIG. 2, fuel reservoir 22 has a large face 25. Face 25 may be substantially planar. In some embodiments, face 25 is in thermal contact with fuel cells 26. In such embodiments, face 25 may contact fuel cells 26 or a support structure for fuel cells 26 directly or there may be one or more thermally-conductive elements between face 25 and fuel cells 26. In the illustrated embodiment, fuel reservoir 22 has a prismatic configuration. This provides a large surface area to release heat when fuel reservoir 22 is filled with fuel. Fuel reservoir 22 may be in thermal contact with fuel cells 26 so that heat released by operation of fuel cells 26 is transferred to fuel reservoir 22 during operation of power source 10.

In some embodiments, the array of fuel cells 26 comprises a plate 27 that contacts face 25 of fuel reservoir 22. Plate 27 may perform one or more of the following functions:
supporting fuel cells 26;
acting as a heat transfer path between fuel cells 26 and fuel reservoir 22;
supporting conductors for carrying electrical current from fuel cells 26; and
providing thermal insulation between fuel cells 26 and fuel reservoir 22.

In some embodiments, plate 27 comprises a printed circuit board carrying metal traces that serve as heat conductors and/or electrical conductors. Plate 27 may comprise through-holes containing plated metal or other thermally-conductive materials to provide a path of high thermal conductivity between fuel cells 26 and fuel reservoir 22. If it is desired that fuel cells 26 and fuel reservoir 22 be thermally insulated from one another then a layer of insulating material may be provided between plate 27 and fuel reservoir 22.

In other embodiments face 25 and fuel cells 26 may be thermally-insulated from one another. In such embodiments there may be electrical circuitry, insulating material, a gap or the like between face 25 and fuel cells 26.

Fuel reservoir 22 may be constructed in a prismatic form. A prismatic form can permit power source 10 to have a more ergonomic flattened form factor than would be possible if fuel reservoir 22 were cylindrical.

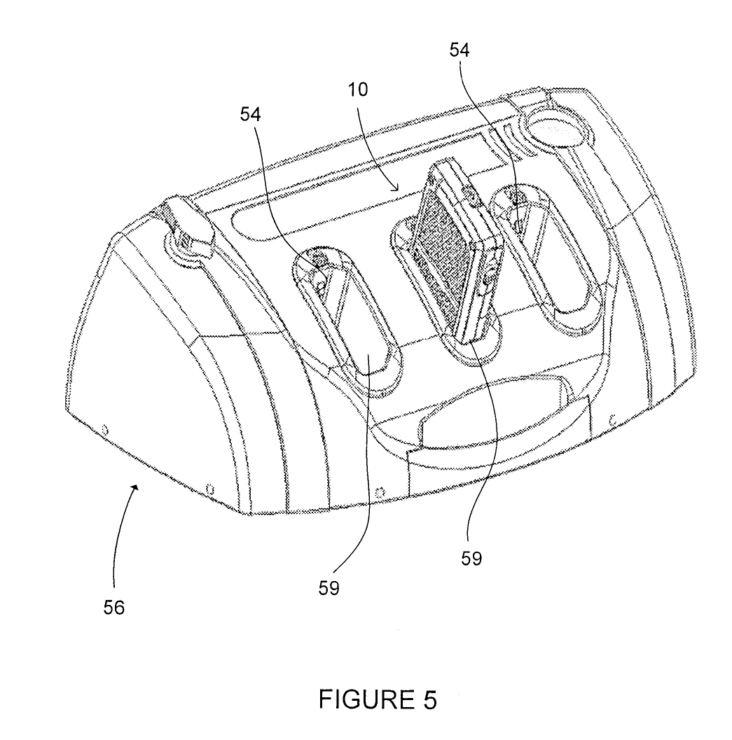

FIG. 5 shows power source 10 being refueled by refueling station 56. Refueling station 56 has slots 59 into which power source 10 can be placed. Refueling station 56 is typically connected to an external source of compressed hydrogen such as a T-cylinder. Alternatively, refueling station 56 may have on-board storage of compressed hydrogen for refueling power source 10. Example refueling stations are described in the co-pending United States patent application entitled Refueling Station being filed on 25 Sep. 2006, and U.S. patent application No. 60/719,604 filed 23 Sep. 2006, both of which are hereby incorporated herein by reference. As discussed below, a mechanism in refueling station 56 engages refueling port 20 on power source 10. Another mechanism 54 engages notch 24 on power source 10 to hold power source 10 in place while it is being refueled. Refueling station 56 supplies fuel to power source 10. Any suitable fuel may be delivered from refueling station 56.

In an example embodiment in which refueling station 56 supplies hydrogen fuel, hydrogen may be supplied at or above the charging pressure of an on-board reversible hydrogen-storage material contained in fuel reservoir 22. In one such embodiment, refueling station 56 supplies hydrogen gas at 150 psi in order to charge the onboard reversible hydrogen-storage material in fuel reservoir 22 of power source 10. Other charge pressures are also possible.

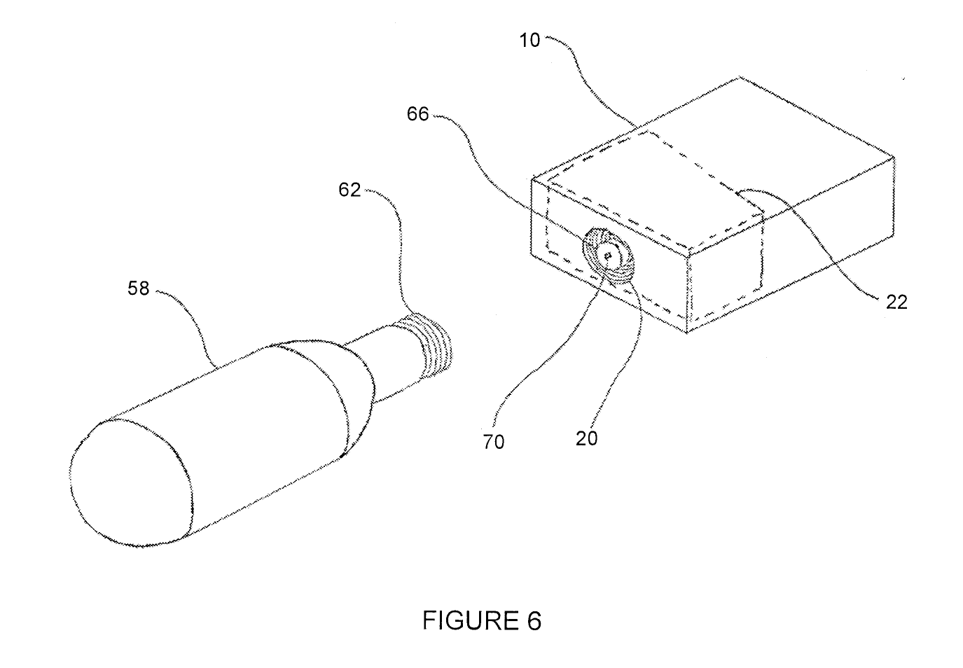

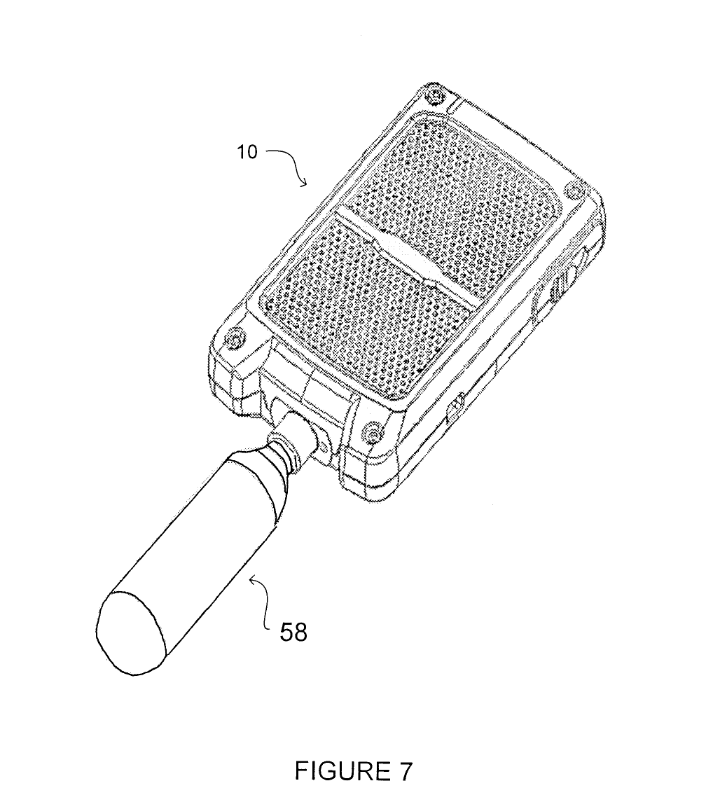

FIGS. 6 and 7 show another possibility for refueling power source 10. If greater portability is required, portable refueling cartridge 58 can be attached to power source 10. Portable refueling cartridge 58 is attached to power source 10. Fuel from cartridge 58 is transferred into power source 10 by way of refueling port 20. Any suitable fuel may be delivered from cartridge 58. Non-limiting examples of suitable fuels include hydrogen, methanol, formic acid, butane and borohydride compounds.

The portable refueling cartridge 58 does not necessarily need to have a regulator in it. For example, portable refueling cartridge 58 could contain hydrogen compressed at a high pressure (e.g., 500-5000 psi). Inlet flow restrictor 48 of power source 10 restricts the flow of hydrogen gas into a reversible hydrogen-storage material of fuel reservoir 22 in order to prevent excessive pressure build-up inside fuel reservoir 22.

If the pressure does build up too high, or if a user attempts to refuel fuel reservoir 22 when it is already full, pressure relief valve 29 in power source 10 will activate and relieve any excess pressure. This is because fuel reservoir 22 and portable refueling cartridge 58 are in fluid communication when the two are engaged for refueling. Thus, pressure relief valve 29 acts as a safety mechanism to prevent excessive pressure build-up in fuel reservoir 22 both when it is on its own and while being refueled by portable refueling cartridge 58.

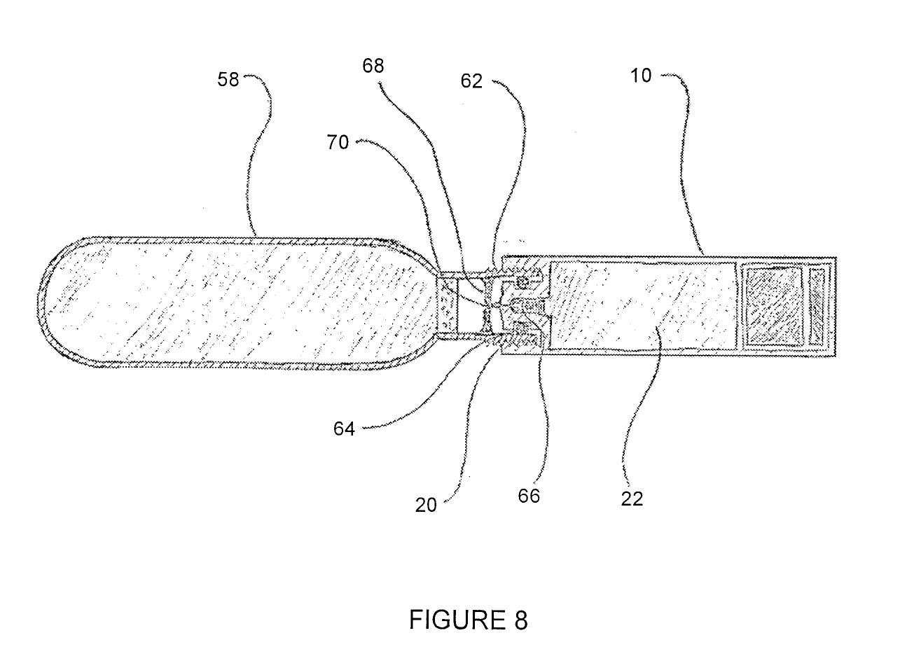

FIG. 8 is a cross-sectional view showing an example embodiment of portable refueling cartridge 58 engaging power source 10. To refuel power source 10, portable refueling cartridge 58 is inserted into refueling port 20 to create an interconnect, which is disposed on power source 10. A holding mechanism 62, which may be disposed on portable refueling cartridge 58, provides a rigid engagement between portable refueling cartridge 58 and power source 10, by connecting to refueling port 20, an exterior surface of power source 10, or any other combination that results in ensuring that portable refueling cartridge 58 is firmly attached to power source 10. Holding mechanism 62 may comprise threads, a bayonet connection, a friction fit, a magnetic coupling or any of numerous other suitable designs. In the illustrated embodiment, holding mechanism 62 comprises screw threads which matingly engage corresponding screw threads associated with refueling port 20. A suitable seal 64, such as an o-ring or gasket may be provided to seal the interconnect between refueling port 20 and portable refueling cartridge 58.

In the illustrated embodiment, fuel reservoir 22 is in fluid communication with refueling port 20 through a charging valve 66 disposed in power source 10 between fuel reservoir 22 and refueling port 20. Charging valve 66 enables fuel to flow from portable refueling cartridge 58 to fuel reservoir 22 when portable refueling cartridge 58 is connected to power source 10, but prevents the discharge of fuel from refueling port 20 after portable refueling cartridge 58 has been disconnected. Portable refueling cartridge 58 provides fuel to power source 10 through a discharge port 68 disposed on the shell of portable refueling cartridge 58. Discharge port 68 comprises a valve, septum or rupture disc that is opened by an actuating mechanism 70. Actuating mechanism 70 may be associated with refueling port 20 so that connecting portable refueling cartridge 58 to refueling port 20 automatically opens discharge port 68 to allow fuel to flow from portable refueling cartridge 58 to fuel reservoir 22.

In the illustrated embodiment, the engagement of power source 10 to refueling station 56 within slot 59 is similar to the engagement of power source 10 to portable refueling cartridge 58. Power source 10 slides into slot 59 and notch 24 is engaged by mechanism 54 in refueling station 56. Slot 59 locates power source 10 so that its refueling port 20 is aligned with a discharge port similar to discharge port 68 of portable refueling cartridge 58. The slot discharge port may comprise a valve, septum or the like that is opened by actuating mechanism 70. As power source 10 is slid into slot 59, a seal is made between refueling port 20 and the discharge port. Further motion of power source 10 into slot 59 causes actuating mechanism 70 to operate so that fuel is transferred into the on-board fuel reservoir of power source 10.

Refueling port 20 of power source 10, including seal 64 and actuating mechanism 70 interacts with the discharge mechanism of slot 59 and discharge port 68 of portable refueling cartridge 58 in similar ways. In the illustrated embodiment, the tip of the discharge port that engages seal 64 of refueling port 20 is small enough in diameter to fit inside the female screw thread that are provided on the illustrated refueling port 20 to engage screw threads of a portable cartridge 58.

Refueling port 20 of power source 10 can be engaged with the discharge port in the illustrated refueling station 56 with a substantially linear motion whereas engaging refueling port 20 with discharge port 68 of the portable refueling cartridge 58 illustrated in FIGS. 6 to 8 requires a relative rotary motion to engage the screw threads of holding mechanism 62. Thus, one advantage of power source 10 is that it is adapted to be interfaced to a plurality of different extrinsic refueling sources (such as portable cartridges and stationary refueling stations) that may have different configurations using the same refueling port 20.

In accordance with an embodiment of this invention, portable fuel cell power source 10 comprises the combination of fuel reservoir 22 for storage of fuel which is provided to fuel cells 26 for generating electricity. The fuel supply is controlled by fuel supply on-off switch 17 and the electricity produced is modulated by power conditioning electronics 28 before being supplied to an external electronic device through electrical connector 52. Electrical connector 52 may be of a standard or universal type that is found in or may be incorporated into many different types of electronic devices. Fuel is supplied to fuel reservoir 22 via a refueling port 20 which is adapted to be connected to different extrinsic refueling sources, such as stationary refueling station 56 or portable refueling cartridge 58.

A portable power source as described herein can have a number of advantages over batteries. It can be used to charge portable electronic devices or directly run portable electronic devices while away from an electrical power grid connection or some other source of power. The power source itself is small and portable and can be conveniently carried to wherever it is required. Example embodiments use air from the ambient environment and contain much less balance of plant components than traditional stationary fuel cell systems. The compressors, humidifiers, heaters, coolers, and other such balance of plant components typically found in other large fuel cell systems are eliminated. This makes for a much simpler, more robust system, and also greatly improves the total volumetric energy density of the system.

As will be apparent to those skilled in the art in the light of the foregoing disclosure, many alterations and modifications are possible in the practice of this invention without departing from the spirit or scope thereof. For example, the features of the embodiments described above may be combined in combinations or sub-combinations that are not explicitly described above or elements of the described embodiments may be substituted by functional equivalents thereof. Accordingly, the scope of the invention is to be construed in accordance with the substance defined by the following claims.

What is claimed is:

1. A portable fuel cell power source comprising:
an exterior case;
a fuel reservoir within the exterior case;
one or more fuel cells in fluid communication with the fuel reservoir;
a fuel supply control switch disposed between the fuel reservoir and the one or more fuel cells to selectively permit or inhibit the flow of fuel from the fuel reservoir to the fuel cells; and,
a refueling port associated with the fuel reservoir and adapted to attach to an extrinsic refueling source.

2. A portable fuel cell power source according to claim 1 in combination with the extrinsic refueling source , wherein the extrinsic refueling source comprises a stationary refueling station or a portable refueling cartridge.

3. A portable fuel cell power source according to claim 2, comprising a holding mechanism associated with the extrinsic refueling source.

4. A portable fuel cell power source according to claim 3, wherein the extrinsic refueling source comprises a portable refueling cartridge, the refueling port comprises screw threads and the holding mechanism comprises mating screw threads for releasable attachment of the portable refueling cartridge to the refueling port.

5. A portable fuel cell power source according to claim 4, wherein
the exterior case comprises a notch formed thereon; and
the stationary refueling station comprises a slot sized to fit the exterior case of the power source and a notch latching mechanism for releasable attachment of the stationary refueling station to the refueling port.

6. A portable fuel cell power source according to claim 1, wherein the fuel comprises hydrogen.

7. A portable fuel cell power source according to claim 1, wherein the fuel comprises a member of the group consisting of: methanol; butane; formic acid; and a borohydride compound.

8. A portable fuel cell power source according to claim 6, comprising a metal hydride material within the fuel reservoir for storing the hydrogen fuel.

9. A portable fuel cell power source according to claim 1, wherein the one or more fuel cells comprise cathodes and the cathodes are in fluid communication with ambient air.

10. A portable fuel cell power source according to claim 9, comprising a grille in the exterior case, wherein one or more apertures in the grille provide pathways for fluid communication between ambient air and the cathodes of the fuel cells.

11. A portable fuel cell power source according to claim 1, comprising an electrical connector provided in the exterior case and connected to an output of the one or more fuel cells, wherein the electrical connector is adapted to connect the power source to an external electronic device to power the external electronic device directly or to charge one or more batteries within the external electronic device.

12. A portable fuel cell power source according to claim 11, wherein the electrical connector is a Universal Serial Bus connector.

13. A portable fuel cell power source according to claim 1, comprising a pressure relief valve in fluid communication with the fuel reservoir.

14. A portable fuel cell power source according to claim 13, wherein the pressure relief valve is operable while the power source is being refueled by the extrinsic refueling source.

15. A portable fuel cell power source according to claim 1, comprising power conditioning electronics connected to an electrical output of the one or more fuel cells, the power conditioning electronics producing a regulated voltage output.

16. A portable fuel cell power source according to claim 1 having a volume in the range of 1 cc to 1000 cc.

17. A portable fuel cell power source according to claim 15 having a volume in the range of 3 cc to 250 cc.

18. A method for refueling a portable fuel cell power source comprising:
providing a portable fuel cell power source having a refueling port that is configured to connect to a stationary refueling station and is also configured to connect to a portable refueling cartridge;
connecting the refueling port of the portable fuel cell power source to an extrinsic refueling source, comprising a stationary refueling station or a portable refueling cartridge; and
transferring fuel from the extrinsic refueling source to a fuel reservoir in the portable fuel cell power source.

19. A method according to claim 19 wherein the fuel comprises a material selected from the group consisting of: hydrogen gas; formic acid; butane;
methanol; and borohydride compounds.

20. A method according to claim 19 wherein the portable fuel cell power source has a volume in the range of 1 cc to 1000 cc.

21. A method according to claim 19 wherein the portable fuel cell power source has a volume in the range of 3 cc to 250 cc.
